(19) United States
(12) Patent Application Publication
(10) Pub. No.: US 2006/0194026 A1
(43) Pub. Date: Aug. 31, 2006

(54) Insulated roofing systems

(75) Inventors: Christopher Blair, Littleton, CO (US); Daniel Edward Bullock, N. Attleboro, MA (US); Christopher Michael Comeaux, Worcester, MA (US)

Correspondence Address: ASPEN AEROGELS INC.;IP DEPARTMENT, 30 FORBES ROAD, BLDG. B, NORTHBOROUGH, MA, 01532, US

(73) Assignee: ASPEN AEROGELS, INC., Northborough, MA (US)

(21) Appl. No.: 11/362,436

(22) Filed: Feb. 24, 2006

Related U.S. Application Data
(60) Provisional application No. 60/593,943, filed on Feb. 25, 2005.
(60) Provisional application No. 60/593,989, filed on Mar. 2, 2005.

(51) Int. Cl. B32B 1/00

(52) U.S. Cl. 428/174

(57) ABSTRACT

Embodiments of the present invention describe a roofing component comprising: asphalt, cellulose, stone, thermoset polymer, thermoplastic polymer, metal, ceramic, concrete or a combination thereof; and an aerogel material. Said aerogel material is integral or a distinct separate layer in relation to the component.

### CROSS-REFERENCES TO RELATED APPLICATIONS

This application claims benefit of priority from U.S. Provisional Patent Applications 60/593,943 (filed Feb. 25, 2005) and 60/593,989 (filed Mar. 2, 2005) both hereby incorporated by reference in their entirety as if fully set forth.

### FIELD OF INVENTION

The present invention pertains in general to insulation of buildings and particularly to building exteriors and roofing.

### SUMMARY OF THE INVENTION

Embodiments of the present invention describe a roofing component comprising: asphalt, cellulose, stone, thermoset polymer, thermoplastic polymer, metal, ceramic, concrete or a combination thereof; and an aerogel material. Said aerogel material is integral or a distinct separate layer in relation to the component.

### DESCRIPTION OF FIGURES

FIG. 1 illustrates a ducting system comprising a metal duct 2, lap insulation 4 and twine 6.

FIG. 2 illustrates a floor/foundation insulated with an aerogel material 14 applied to the floor 12, wood beam sleepers 16 and concrete slab 18.

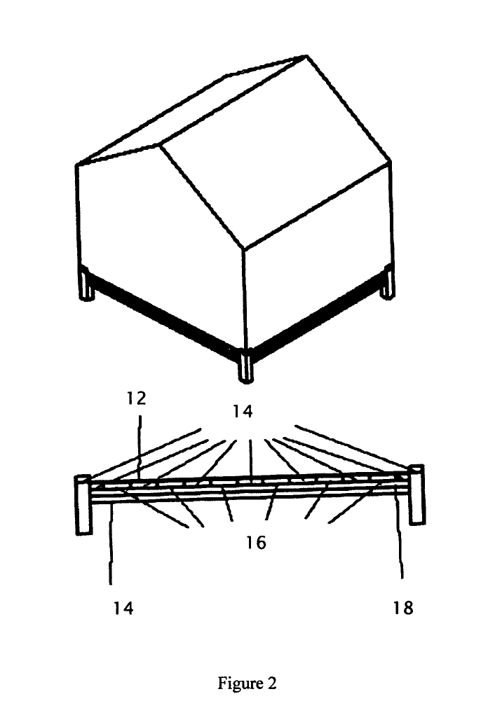

### DESCRIPTION OF THE INVENTION

Insulation in roofing is important in that this region represents the last line of thermal containment for the heat in the internal air rising and escaping from a building. It may also be viewed as an important thermal barrier to the undesirable exterior temperatures. That is, roofing assists in keeping the interior of a building warm when it's cold out and warm when it's cold out. Insulation of roofing components such as shingles are of interest particularly in cathedral style homes where the internal atmosphere is in thermal contact with the roof. To this end, the present invention describes a series of novel aerogel-insulated roofing components. Though, it is noted that embodiments of the present invention are applicable to building exteriors on whole, where one such example involves sidings for outer walls.

Roof shingles are constructed from a variety of materials such as rubber, wood, metals, ceramics and combinations thereof. Furthermore they may take on a variety of forms such as, planar, curved, wavy, corrugated, rippled, saw-toothed, faceted, and a variety of others. Added insulation, especially with aerogel materials, can result in a more energy efficient use of such shingles. Additionally for humid environments, hydrophobic aerogels which are readily available from Aspen Aerogels inc., represent a very attractive choice. Also, with inherent fire-resistant properties of aerogels, many safety codes can be met and without any hindrance of installation.

Aerogels materials are excellent insulators due mainly to their low density and highly porous structure. The sol-gel process is one method for preparing gel materials, where upon drying can result in aerogels. Sol-gel process is described in detail in Brinker C. J., and Scherer G. W., Sol-Gel Science; New York: Academic Press, 1990; hereby incorporated by reference.

Within the context of embodiments of the present invention “aerogels” or “aerogel materials” along with their respective singular forms, refer to gels containing air as a dispersion medium in a broad sense, and include aerogels, xerogels and cryogels in a narrow sense. The chemical composition of aerogels can be inorganic, organic (including polymers) or hybrid organic-inorganic. Examples of inorganic aerogels include, but are not limited to silica, titania, zirconia, alumina, hafnia, yttria, ceria, carbides and nitrides. Organic aerogels can be based on compounds such as but are not limited to: urethanes, resorcinol formaldehydes, polyimide, polyacrylates, chitosan, polymethylmethacrylate, members of the acrylate family of oligomers, trialkoxysilyl terminated polydimethylsiloxane, polyoxyalkylene, polyurethane, polybutadiane, melamine-formaldehyde, phenol-furfural, a member of the polyether family of materials or combinations thereof. Examples of organic-inorganic hybrid aerogels include, but are not limited to: silica-PMMA, silica-chitosan, silica-polyether or possibly a combination of the aforementioned organic and inorganic compounds. Published US patent applications 2005/0192367 and 2005/0192366 teach extensively of such hybrid organic-inorganic materials and are hereby incorporated by reference in their entirety.

Drying may be accomplished using a variety of methods known in the art. U.S. Pat. No. 6,670,402 herein incorporated by reference, teaches drying via rapid solvent exchange of solvent(s) inside wet gels using supercritical CO₂ by injecting supercritical, rather than liquid, CO₂ into an extractor that has been pre-heated and pre-pressurized to substantially supercritical conditions or above to produce aerogels. U.S. Pat. No. 5,962,539 herein incorporated by reference, describes a process for obtaining an aerogel from a polymeric material that is in the form a sol-gel in an organic solvent, by exchanging the organic solvent for a fluid having a critical temperature below a temperature of polymer decomposition, and supercritically drying the fluid/sol-gel. U.S. Pat. No. 6,315,971 herein incorporated by reference, discloses processes for producing gel compositions comprising: drying a wet gel comprising gel solids and a drying agent to remove the drying agent under drying conditions sufficient to minimize shrinkage of the gel during drying. Also, U.S. Pat. No. 5,420,168 herein incorporated by reference describes a process whereby Resorcinol/Formaldehyde aerogels can be manufactured using a simple air drying procedure. Finally, U.S. Pat. No. 5,565,142 herein incorporated by reference describes subcritical drying techniques. The embodiments of the present invention can be practiced with drying using any of the above techniques. In some cases, it is preferred that the drying is performed at vacuum to below super-critical pressures (pressures below the critical pressure of the fluid present in the gel at some point) and optionally using surface modifying agents.

Aerogels can be opacified with compounds such as but not limited to: B₄C, Diatomite, Manganese ferrite, MnO, NiO , SnO , Ag₂O , Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof. Opacification can assist in reducing the radiative component of heat transfer.

Aerogels may be prepared in fiber-reinforced composite form. The fiber-reinforcement may comprise organic polymer-based fibers (e.g. polyethylenes, polypropylenes, polyacrylonitriles, polyamids, aramids, polyesters etc.) inorganic fibers (e.g. carbon, quartz, glass, etc.) or both and in forms of, wovens, non-wovens, mats, felts, battings, lofty battings, chopped fibers, or a combination thereof. Aerogel composites reinforced with a fibrous batting, herein referred to as “blankets”, are particularly useful for applications requiring flexibility since they can conform to three-dimensional surfaces and provide very low thermal conductivity. Aerogel blankets and similar fiber-reinforced aerogel composites are described in published U.S. patent application 2002/0094426A1 and U.S. Pat. Nos. 6,068,882, 5,789,075, 5,306,555, 6,887,563, and 6,080,475, all hereby incorporated by reference, in their entirety. Some embodiments of the present invention utilize aerogel blankets, though similar aerogel composites (e.g. those disclosed by reference) may also be utilized.

In an embodiment the aerogel material(s) are encapsulated in an envelope for various reasons such as dust (e.g. flaking) containment, protection from external elements, retention at reduced pressures or simply containment to a particular region. Typically polymeric envelopes are preferable, although other materials, including composites may be desired. General examples of polymeric materials suitable for envelopes include but are not limited to: polyesters, polyethylenes, polyurethanes, polypropylenes, polyacrylonitriles, polyamids, aramids, more specifically polymers such as polyethyleneterphthalate, low density polyethylene, ethylene-propylene co-polymers, poly(4-methyl-pentane), polytetrafluoroethylene, poly(1-butene), polystyrene, polyvinylacetatae, polyvinylchloride, polyvinylidenechloride, polyvinylfluoride, polyvinylacrylonitrile, plymethylnethacrylate, polyoxymethylene, polyphenylenesulfone, cellulosetriacetate, polycarbonate, polyethylene naphthalate, polycaprolactam, polyhexamethyleneadipamide, polyundecanoamide and polyimide. In a preferred embodiment Tyvek® is used as the polymeric sheet.

In one embodiment the aerogels are coated with a polymeric material. This may be carried out to reduce free particulate matter on the surface of the aerogel material, provide an abrasion resistant surface, protect from external elements, or other reasons. The coating may be applied by spraying, lamination or other techniques known in the art. Suitable coatings include but are not limited to: acrylic coatings, silicone-containing coatings, phenolic coatings, vinyl acetate coatings, ethylene-vinyl acetate coatings, styrene-acrylate coatings, styrene-butadiene coatings, polyvinyl alcohol coatings, polyvinyl-chloride coatings, acrylamide coatings, copolymers or combinations thereof. The coatings may be further subject to a heat treatment step, cross-linking agents, or both.

Embodiments of the present invention describe a roofing component comprising: a material comprising asphalt, cellulose, stone, thermoset polymer, thermoplastic polymer, metal, ceramic, concrete or a combination thereof; and an aerogel material. Said aerogel material is integral or a distinct separate layer in relation to the component. In the embodiments, the roofing component includes shingles. “Shingles” as used herein comprises all other forms of roofing exemplified by, but not limited to: “panels”, “tiles” and “shakes”. In some embodiments, the roofing component is also applied to the external sections of a building other than roofs further exemplified by but not limited to “sidings” and “panels”. In some cases the aerogel material is applied to the back surface (or backside) of a shingle (or roofing component) which in general refers to surface(s) (or side(s)) that essentially face the interior of the building.

In one embodiment, the roofing component comprises an asphalt material. One of the most popular types of roofing materials is asphalt. The two major forms of asphalt shingles are the three-tab and architectural shingles with the latter being a thicker form. The advantages of using asphalt shingles include: low cost, multiple available colors and good lifetime (20-30 years). Asphalt shingles are also poor thermal insulators with a typical R-value (ft²h °F/BTU) of about 0.4 per inch. One method of increasing this insulating value is by adding an aerogel material (˜R−12/ inch) to the panel structure. Since R values are cumulative, the overall value could increase to R−12.4, representing an improvement of better than 30 times in insulation. There are numerous ways of adding an aerogel material to asphalt shingle composites including: external application of blankets and particles as well as incorporation of particles within the asphalt matrix. A separate layer of an aerogel blanket could be adhered to the back side of each asphalt shingle either covering the entire surface or only the top half. Alternatively, no adhesive could be used such that by the virtue of attaching the asphalt shingle (e.g. nailing to the roof) the blanket is also secured. Alternatively the aerogel material, in particulate form could be sprayed on along with an adhesive onto the backside of the shingles. In all cases, the insulated shingles could be nailed or otherwise secured, using methods commonly practiced in the art, to the roof.

In another embodiment, the roofing component comprises a cellulosic material such as wood. Wood shingles represent one of the more aesthetically appealing types of roofing. In addition they have typical lifetimes of 30 to 50 years. The insulation value for wood shingles is about R−1, and therefore could increase significantly from added insulation of aerogels. In instances where solid wood is used, an aerogel blanket or aerogel particles sprayed with an adhesive could be applied to the rear surface of the shingles. As before, the entire back surface or the top half could be covered. Plywood and particle boards are also possible for roofing and may be improved in thermal performance. Aerogel blankets or particles can be placed as an inter-ply (or dispersion) in the plywood form or as embedded particles during the processing of particle boards. Also aerogel blankets could be adhered to the rear surface of such shingles. Alternatively, no adhesive could be used such that by the virtue of attaching the wood shingle (e.g. nailing to the roof) the blanket is also secured. In all cases, the shingles would be nailed or otherwise secured as commonly practiced in the art, to the roof.

In another embodiment, the roofing component comprises stone in a bound particle or monolithic forms, where a common commercial variety is referred to as “Slate.”Slate is a high density stone that has found use as a roofing material for centuries. Due to many naturally occurring variances in texture and color, a high aesthetic value in addition to durability is derived from using slate. Other advantages include Non-Combustibility, acid-resistance, UV-stable, environmental friendliness, low maintenance, non-staining and moisture impermeable. However, slate suffers from low heat flow resistance (R−0.12/ in.) To remedy this, an aerogel blanket or aerogel particle sprayed with an adhesive could be applied to the rear surface of a slate shingle. Alternatively, no adhesive could be used such that by the virtue of attaching the shingle (e.g. nailing to the roof), the blankets are also secured. Either the entire back surface or the top half of the shingle could be covered. This will not impede the normal practice of nailing, or otherwise securing, the slate shingles to the roof.

In another embodiment, the roofing component comprises polymeric materials. Examples include thermoplastics, thermosets, and composites thereof. Shingles can also be designed to resemble the appearance of slate using polymer-based materials such as plastics and rubber. Plastics/rubbers can have some porosity in their structure. An aerogel can-be introduced (cast) into an open cell structure of plastic/rubber slate. This should not affect the structural properties and if the aerogel is formed properly, the thermal performance should be enhanced. Other ways to incorporate the aerogel into the shingles is to cast the shingle with an aerogel material, affixing the aerogel to one of the surfaces of the shingle, or to cast the shingle around a aerogel material. A shingle could be cast around or onto one or more of the sides of the aerogel in the case of plastic/rubber slates through a process technique (eg. injection molding, extrusion) resulting in the polymeric material attached to the aerogel material (eg. monolith or blanket). Such shingles can be secured to the roof using common methods practiced in the art such as nailing.

In another embodiment, the roofing component comprises a metallic material. Metal roofing (shingles) structures have enjoyed use in barns, sheds, agricultural and utility buildings for many years. The main form is typically that of corrugated, galvanized sheets. With an R value of about 0.1 metal roofing is a poor thermal insulator. Metal roofing can be further insulated by laminating aerogel blankets directly onto the metal using an adhesive or through other securing mechanisms. Alternatively, aerogel particles can also be sprayed, along with an adhesive onto the rear surface of the metal roofing. Yet another method would be to cast aerogel monoliths (with or without fiber reinforcement) directly to the roofing. As before, the metal roofing in this instance can be installed with methods common in the art such as nailing.

In another embodiment, the roofing component comprises a ceramic material. Ceramic tile (shingle) roofs are typically found throughout the Mediterranean and U.S. states such as California and Florida. In addition to the aesthetic value of these shingles, ceramic tiles can last as long as 60 to 80 years. Aerogel materials in the form of a flexible blanket could be adhered onto the back side of ceramic shingles and can accommodate the contours of rippled ceramic shingles as well. Alternatively, no adhesive could be used such that by the virtue of attaching the shingle (e.g. nailing to the roof) the blankets are also secured. Aerogel particles blown with an adhesive would represent another form of securing aerogel insulation onto the backside of such shingles. Ceramic tiles when constructed from clay fired at temperatures below 1100° F. could incorporate aerogel particles within the matrix. Aerogels incorporated into the pre-fired clay can remain in the matrix since aerogels (e.g. inorganic-based) are typically stable even up to 1100° F. Accordingly, added insulation may be achieved without compromising the overall mechanical integrity or aesthetic appeal of the ceramic material. Such modified ceramic shingles could be secured to a roof with methods commonly practiced in the art.

In another embodiment, the roofing component comprises concrete. concrete tiles (shingles) are a product that resemble ceramic tiles but are less costly. In some versions concrete tiles are a fibrous composite. The fibers are wood fibers or inorganic fibers for added strength. Concrete tiles would benefit tremendously from added insulation considering the low R value of such materials is typically around R−1. As in the previous embodiments, aerogel blankets or particles could be affixed to the rear of these shingles. Alternatively, no adhesive could be used such that by the virtue of attaching the shingle (e.g. nailing to the roof) the blankets are also secured. Additionally, aerogel materials either embedded in a rigid polymer such a polyurethane (as a monolith or flexible blanket)or be placed between two layers of concrete, making up the entire structure of the insulated tile. The plies comprising the aerogel-sandwiched concrete tile could be secured using fiber composite connectors such as those used in Thermomass® (a product of Composite Technologies Corporation). Furthermore, the porous nature of concrete materials allows for impregnation with aerogel particles. The porous concrete material could be placed in a sol solution, allowing the aerogel precursor materials to penetrate the pores, followed by extraction (supercritical or sub-critical) of the solvents and aging to essentially fill the concrete pores with aerogels. Depending on the porosity of the concrete material added insulation could be achieved considering that air(˜R−0.15) is being replaced with aerogels (˜R−12) Such shingles could be installed using common carpentry practices such as nailing.

In a special embodiment an underlay for the shingles is provided which comprises an aerogel material. Preferably the underlay comprises a fiber reinforced aerogel material, such as the aerogel blankets previously described. More preferably the underlay is an aerogel blanket encapsulated in an envelope that is weather proof. The envelope may be chosen from a variety of polymeric materials such as but not limited to Tyvek®, Typar®, Amowrap®, Barricade®, R-wrap®, PinkWrap® among others. The underlay may be placed on the roof directly in contact with the roof structural components or with layer(s) in between. The shingles may be installed on top of the underlay.

In another aspect of the present invention, aerogel materials are utilized in thermal management of buildings. There are many types of buildings that may benefit from form such insulation including but not limited to: residential, commercial and industrial. Within these units there are many regions that may require thermal (and possibly acoustic) insulation which include but are not limited to: flooring, roofing, ducting, windows and fenestration perimeters, structural elements (e.g. beams, blockings, etc.), ceiling elements, wall elements (including wall boards), fire place elements, foundation elements, stove ventilation elements, chimney elements and many others.

Flooring in general includes tiles, rugs, carpets and the like. Floor tiles such as those utilized in residential areas are usually constructed form vinyl, ceramic, wood, or other such materials. In one embodiment, flooring comprising such materials may also comprise a layer of aerogel material as a layer attached to the backing of said flooring or incorporated therein (i.e. prefabricated with aerogels.) For instance the aerogel material may be in particulate or blanket form and applied to the bottom side of a flooring tile via spraying, adhesive layer, mechanical fastening or a combination thereof. Where rugs and carpets are concerned the aerogel material is similarly attached separately or integrated. Furthermore, the aerogel material, in particular in blanket form may also be secured via mechanical means such as tags, stitches and the like.

In another embodiment, plumbing systems, which in general comprise pipes, joints and other elements are insulated with aerogel materials. Insulation with aerogels materials can provide thermal as well as acoustic insulation in this area of buildings. In a further aspect, insulation with aerogel materials also serves a barrier to spread of fire for pipes conveying flammable fluids. Still, other advantages exist for using aerogel material as insulation. For instance some residential homes utilize steam water lines as a means for distributing heat. Covering the seam lines, where heat dissipation is not desired would enable this system to operate more efficiently. Of course the source of steam and hot water (e.g. water heater) is also of interest and may also be similarly insulated with an aerogel material. The aerogel material may be in particulate, blanket (or both) forms and applied around plumbing elements via an adhesive layer, adhesive tape, shrink wrapped over layer, mechanical fastening means or a combination thereof. Securing methods such as posts, screws and adhesives may also be used to hold the aerogel in place. Aerogel materials are advantageous since they may provide a large R−value (˜12/ inch) as compared to other materials such as fiberglass (˜6/ in.) Furthermore, longer lines can be used since such changes in dimension would previously have presented issues of increase heat loss. Additionally, the aerogel material may be encased in a high density polymeric material such as Tyvek® for moisture protection. Also, the aerogel material in a non-blanket form such as individual particles could be spared on along with an adhesive material on the outer surface of the pipe to achieve a similar insulation effect.

Roofing is an area of interest as many building structures, particularly those in the industrial sector since roofing assumes a large portion of the building's envelope and thus requires a more effective thermal management. In another embodiment, a roofing element is insulated with an aerogel material. Aerogel materials in blanket, particulate (or both) forms can be placed as an underlayment below the roofing material to provide additional insulation and a barrier to the hot air rising in the interior of the building. Securing methods such as posts, screws and adhesives may also be used to hold the aerogel in place. In apreferred embodiment, the aerogel material is encases in a moisture resistant material such as Tyvek® to prevent from insulation loss due to moisture penetration in the aerogel material. In another embodiment, the aerogel material is incorporated into the roofing element. Furthemore, the roofing element may be further improved with foil or metallic backing.

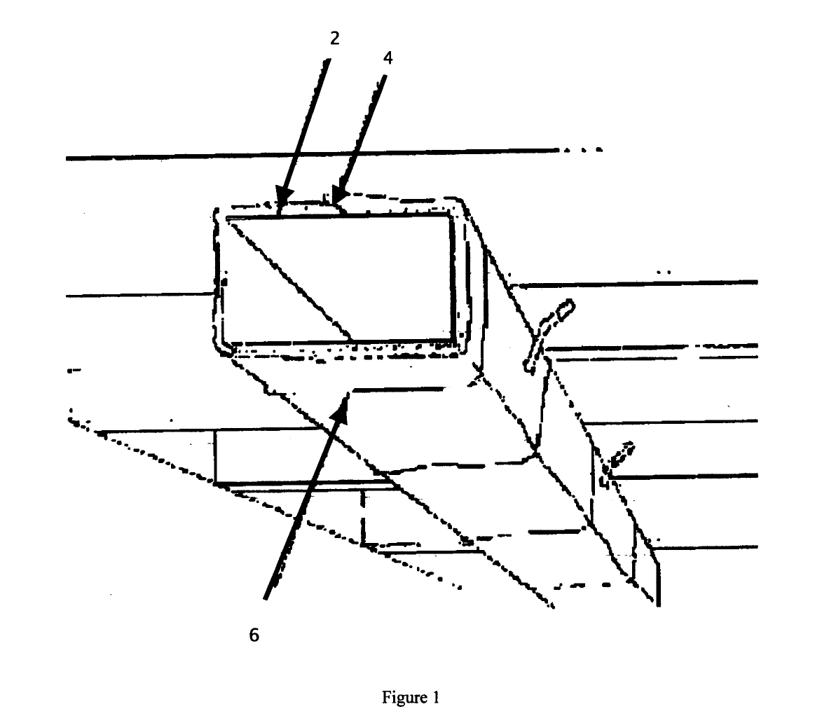

In yet another embodiment, ducting elements are insulated with aerogel materials. Space conditioning (heating, ventilation, cooling, dehumidification) in commercial and residential buildings are delivered by ducting systems. The two main mechanisms for duct system energy loss is by direct conduction of heat from a warm duct surface (or by warming of a cooled surface by ambient warm air in air conditioning) and air leaks through gaps, seams and cracks in the ductwork, or ducting elements. On average, typical duct systems in residential buildings lose between 25 and 40 percent of the heating or cooling energy generated, with conductive losses representing at least 50 percent of the total when the ducts are placed outside of the conditioned spaces. Estimates show that 0.5-1.3 kWh/ft² can be saved annually in light commercial buildings with ductwork outside the building envelope and 1-2 kWh/ft² in large commercial buildings. The vast majority of installed duckwork in residential and light commercial buildings is about R−4 or less comparing unfavorably with wall and ceiling insulation levels of about R−19 and about R−38. Using multiple thicknesses of currently utilized duct insulation materials would increase R values but would also make installation more difficult where only small clearances are available. The aerogel material may be in particulate or blanket form and applied around ducting or ducting elements via an adhesive layer, adhesive tape, shrink wrapped over layer, mechanical fastening means or a combination thereof. The aerogel material may also be secured with a polyethylene twin or rust-free wire as illustrated in figure 1. For example, an aerogel blanket can be encapsulated with aluminum foil and secured to a round sheet metal duct using a stainless steel wire as the fastener. Furthermore, these blankets can be en capsulated in a high density polymeric material such as Tyvek® where this also meets the thermal performance requirement for duct super-insulation material (heating or cooling air flows) with a thickness of ¾″ or less. In another aspect, insulation of furnaces are of interest. Furnaces can also be insulated as in a similar manner to the ducting segments to achieve a more efficient heat management.

In another embodiment, high concentration framing regions are of interest. Construction materials are typically poor thermal insulators (good thermal conductors.) For instance, wood and steel which exhibit R values of about 1 and about 0.003 respectively. As such regions where a large concentration of framing elements exist represent points where heat can be carried away (or into) at a high rate. Exemplary regions are window perimeters, door perimeters, wall/wall intersections, wall/floor intersections, wall/ceiling intersections, and other similar areas. Perimeter areas can be much more conductive that clear wall areas. In an example involving window perimeter of a wooden structured building, insulation with aerogel materials can be place over such regions thereby mitigating heat loss to the exterior of the building. For example, a layer of aerogel materials in particulate, blanket (or both) forms can be placed between the frames and the wood beams. As before, securing methods such as posts, screws and adhesives may also be used to hold the aerogel in place.

In another embodiment, regions between structural elements are of interest. Preventing heat flow across structural elements of a building can prove very useful particularly where the elements are good thermal conductors. This can be achieved in a variety of ways. Structural insulated panels (SIP) provide one effective solution. SIPs typically take the generic form of an insulating, yet mechanically rigid material sandwiched between two structural materials that include wood, steel, or other such materials. It has been shown that a 4 inch SIP wall outperforms 2″×4″, and even 2″×6″stick and batt construction in terms of performance. Because SIPs are the structural elements, there are no studs or braces to cause breaks in the insulating action. This contributes to a more comfortable, energy efficient structure that performs well in real-world conditions. Unlike stick and batt construction, which can be subject to poorly installed insulation, the nature of SIPs is such that the structural and insulating elements are joined as one. No hidden gaps exist, because a solid layer of foam insulation is integral to panel construction. The current embodiment utilizes an aergel material in the form of particles, blankets or both as the insulating component of a SIP.

Another embodiment involves ceilings and walls. Aerogel materials in particulate, blanket (or both) forms may be placed within ceilings and walls for added insulation. In a mode of practice aerogel particulates are blown in along with an adhesive onto the exterior of a wall or ceiling or inside a cavity therein. Optionally, a coating can be applied to protect the aerogel material (e.g. when aerogel is applied externally) from abrasion and external factors. Additionally, ceiling and wall tiles or panels can be constructed with aerogel backings or infused aerogel particles,

In one embodiment, a wallboard material comprising aerogel materials is of interest. The wallboard sections of a typical building make up a large percentage of the internal surface area. A common type of wall board is gypsum-type (e.g Sheet rock® ) In one example, the aerogel material in particulate, blanket (or both) forms is incorporated into a wallboard. For instance aerogel particulates may be mixed with gypsum particulates and optionally other additives to obtain a rigid wallboard with improved insulation over gypsum alone.

In another embodiment, fire place and chimneys are of interest. A chimney column typically must travel though a portion of the interior structure of a building. A aerogel material covering the chimney column on the interior of a house for instance, can result in multiple benefits. First, the aerogel materials are excellent barriers to fire. Also, the temperature of the chimney may be isolated from the rest of the building. As before, the aerogel materials may be applied in particulate, blanket (or both) forms. For example aerogel particles may be blown in combination with an adhesive, or a blanket may be attached via and adhesive or a mechanical fastening means (e.g. posts, screws, etc.) onto the exterior surface of the chimney portion penetrating the interior of a building.

Another embodiment concerns building foundations. A foundation is an important region for insulation of a building considering that it is essentially a large surface area of a high thermal conductivity material typically in thermal contact with the cold sub-terrain environment. Concrete, with an R value of about 0.15 is commonly used for foundation structural regions even though it is a good thermal conductor. An aerogel material (R value of about 12) positioned as a surface layer on the concrete can therefore greatly mitigate heat loss through the foundation regions. Foundations typically appear in two forms: Full basement and slab. Full basement forms are more prevalent in the northeastern U.S. while the same is true of slab forms in the western U.S. In the slab from, a rectangular concrete slab is poured for support to the interior floor of a building. A typical slab configuration may comprise from top to bottom: concrete slab, wire mesh, insulation, sand, vapor barrier, and gravel. The insulation is this case may be replaced with an aerogel material in the particulate, blanket (or both) forms. It should be noted that there are many other configurations for foundation areas where the aerogel material may (or may not) be placed differently. The aerogel material may be placed down prior to pouring the concrete (or not.) Another region of interest involves the space between the structure floors and the concrete slab where wood beams are normally placed. Between the beams, aerogel materials (about R−12) can be placed to substantially increase the insulation value (wood: about R−1 and, air: about R−0.16) Foundation walls in a typical setup may include the following elements from outside in: filter fabric for drainage, insulation, waterproofing membrane, concrete wall. The insulation here, as before may be replaced with an aerogel material for improved performance. In a preferred mode of practice the aerogel material is encased in a polymeric material such as polyethylene, (e.g. Tyvek®), polyurethane foam and the like. Such arrangement not only may serve to improved mechanical stability, but also ensures optimum performance from the aerogel material by preventing moisture permeation therein.

In yet another embodiment, kitchen stove ventilations are of concern, particularly those of commercial buildings, which must meet strict fire safety standards. In commercial kitchen settings, a a clearance region is required around the ventilation systems and the neighboring elements, such as walls or shelves. Aerogel materials in particulate, blanket (or both) forms may be placed in the clearance region between stove ventilation and the adjacent wall designed to protect from the ventilation fires. As before securing methods such as posts, screws and adhesives may be used to hold the aerogel material in place.

What is claimed is:

1. An insulated roofing component comprising:
asphalt, cellulose, stone, thermoset polymer, thermoplastic polymer, metal, ceramic,
concrete or a combination thereof; and
an aerogel material wherein said aerogel material is incorporated within said component.

2. The component of claim 1 wherein the aerogel material is in the form of particles, monoliths, composites, or a combination thereof.

3. The component of claim 2 wherein the aerogel material is fiber-reinforced.

4. The component of claim 1 wherein the aerogel material is opacified with B₄C, Diatomite, Manganese ferrite, MnO , NiO , SnO , Ag₂O , Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

5. The component of claim 1 wherein the roofing component is planar, curved, wavy, corrugated, rippled, saw-toothed or faceted.

6. An insulated roofing component comprising:
asphalt, cellulose, stone, thermoset polymer, thermoplastic polymer, metal, ceramic,
concrete or a combination thereof; and
at least one layer of an aerogel material adhered to said roofing component.

7. The component of claim 6 wherein the aerogel material is in the form of particles, monoliths, composites, or a combination thereof.

8. The component of claim 2 wherein the aerogel material is fiber-reinforced.

9. The component of claim 1 wherein the aerogel material is opacified with B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

10. The component of claim 1 wherein the roofing component is planar, curved, wavy, corrugated, rippled, saw-toothed or faceted.

11. The component of claim 7 wherein the aerogel material is coated.

12. The component of claim 7 wherein the aerogel material is encapsulated in an envelope.

13. A method of insulating a building comprising placing a roofing component about said building wherein said roofing component comprises:
a material comprising asphalt, cellulose, stone, thermoset, thermoplastic, metal, ceramic,
concrete or a combination thereof; and
at least one layer of an aerogel material adhered to said roofing component.

14. A method of insulating a building comprising placing a roofing component about said building wherein said roofing component comprises:
a material comprising asphalt, cellulose, stone, thermoset, thermoplastic, metal, ceramic,
concrete or a combination thereof; and
an aerogel material, wherein said aerogel material is incorporated therein.

15. A method of insulating a building comprising placing a layer of aerogel material on a surface of said building wherein said surface is part of a flooring element, or
wherein the surface is part of a plumbing element, or
wherein the surface is part of a roofing element, or
wherein the surface is part of a ducting element, or
wherein the surface is part of a window perimeter area, or
wherein the surface is part of a fenestration perimeter area, or
wherein the surface is part of a structural element, or
wherein the surface is part of a ceiling element, or
wherein the surface is part of a wall element, or
wherein the surface is part of a wall board, or
wherein the surface is part of a fire place element, or
wherein the surface is part of a foundation element, or
wherein the surface is part of a ventilation element, or
wherein the surface is part of a stove ventilation element, or
wherein the surface is part of a chimney element.

16. A wall board comprising gypsum and an aerogel material.

17. The wall board of claim 16 wherein the aerogel material is in particulate form, blanket form or both.
